(19) United States
(12) Patent Application Publication
(10) Pub. No.: US 2012/0257947 A1
(43) Pub. Date: Oct. 11, 2012

(54) DEVICE FOR PRODUCING A BOOK BLOCK

(75) Inventor: Markus MUELLER, Wolfschlugen (DE)

(73) Assignee: KUGLER-WOMAKO GMBH, Nuertingen (DE)

(21) Appl. No.: 13/440,161

(22) Filed: Apr. 5, 2012

(30) Foreign Application Priority Data
Apr. 6, 2011 (DE) 10 2011 006 896.1

(51) Int. Cl. B42C 1/00

(52) U.S. Cl. 412/37

(57) ABSTRACT

Device for producing a book block composed of layers of connected sheets that are creased along a crease line. A stack forming station having a stack forming area assembling creased sheets, provided with glue on their outside, to form a stack for forming a book block and an abutting means delimiting the stack forming area for holding the stack and a pressing device with at least one pressing means generating pressure on the top of the stack to press the stack against the abutting means. During the generation of pressure on the top of the stack, the pressing means moves along the top of the stack in the stack forming area, and the stack forming station has an alignment device aligning a creased sheet with its first outside provided with adhesive to the abutting means.

### CROSS-REFERENCE TO RELATED APPLICATIONS

The present application claims priority under 35 U.S.C. §119 of German Patent Application No. 10 2011 006 896.1, filed on Apr. 6, 2011, the disclosure of which is expressly incorporated by reference herein in its entirety.

### BACKGROUND OF THE INVENTION

1. Field of the Invention

The invention relates to a device for producing a book block, which is composed of layers of sheets connected to one another and folded along a fold line forming a crease edge, with a stack forming station, which in a stack forming area assembles creased sheets, provided with glue on their first outside, to form a stack for forming a book block and an abutting means delimiting the stack forming area for holding the stack and a pressing device with at least one pressing means, which is embodied to generate pressure on the top of the stack in order to press the stack against the abutting means.

2. Discussion of Background Information

A device of this type is used in particular for laminating folded or creased sheets for the purpose of producing a photo book block and is generally part of a system for producing photo book blocks or the like. To this end, a material web unwound from a roller, for example, is printed in a printing station; alternatively or additionally, however, it is also conceivable that the material web wound up on the roller has already been previously printed and/or coated. Subsequently, printed sheets are separated from the material web by cross-cutting. The sheets are folded along a crease line or fold line so that the crease line or fold line forms a crease edge or fold edge. In an adhesive application station the creased sheets are provided with adhesive, before they are assembled to form a stack in a stack forming station, in that respectively two adjacent sides of the creased sheets are connected to one another by the adhesive to form a common side. The creased edges, lying one on top of the other, of the sheets in the stack thereby jointly form the book spine of the book block that is formed from the stack. Subsequently, the finished stack is removed from the stack forming area of the stack forming station and is transported to a downstream station for further processing, in particular for the completion of the book block.

DE 41 41 767 A1 describes a method and an arrangement for producing books and brochures that are composed of creased or folded layers of sheets connected to one another, wherein the top and bottom sheets of the folded layers are adhered to rigid covers. To this end, multiple-up layers are conveyed consecutively and their sheets are connected to one another in at least one connection station by a mechanical binding and subsequently creased or folded in a creasing station. The top and bottom sheets of the creased or folded layers are fed to covers that are adhered to the sheets. Back strips are adhered to the backs of the layers in a backing station. Subsequently, the multiple-up creased lined layers provided with back strips are cut into individual ups in book size in a cutting station.

In EP 0 791 478 A1, which constitutes the closest prior art, on which the present invention is based, a device and a method for book binding are disclosed, wherein firstly the sheets are folded one after the other. The folded sheets are piled to form a stack in a stack forming station, wherein the top of the respectively newly fed folded sheet is sprayed with glue by glue spray nozzles. After the completion of the stack, this is subsequently pressed by a ram in order to achieve the highest possible adhesive effect for a secure connection of the folded layers to one another.

### SUMMARY OF THE INVENTION

The object of the invention is now to create a device of the type mentioned at the outset, which is suitable for an automatic production with high capacity and precision and in particular thereby renders possible a precise alignment of the sheets within the stack to be formed.

This object is attained with a device for producing a book block, which is composed of layers of sheets connected to one another and creased along a crease line forming a crease edge, with a stack forming station, which in a stack forming area combines creased sheets provided with glue on their first outside to form a stack for forming a book block, and an abutting means delimiting the stack forming area for holding the stack and a pressing device with at least one pressing means, which is embodied to generate pressure on the top of the stack in order to press the stack against the abutting means, characterized in that, during the generation of pressure on the top of the stack, the pressing means can be moved along the top of the stack through the stack forming area at the same time, and the stack forming station has an alignment device, which aligns a creased sheet with its first outside provided with adhesive to the abutting means and thus to a sheet or stack already held on the abutting means, wherein the pressing device is furthermore embodied such that the pressing means generates pressure on the second outside of each creased sheet after this sheet has been aligned by the alignment device with its first outside provided with adhesive to the abutting means and thus to the stack held on the abutting means, in order to press this sheet against the stack.

A special feature of the present invention is accordingly to embody and arrange the pressing means such that it not only generates pressure on the top of the stack, but during this also moves along the top of the stack through the stack forming area. To this end the new sheet with the first outside thereof provided with adhesive is accordingly aligned to the abutting means and thus to a sheet or stack already held on the abutting means with the aid of an alignment device likewise provided according to the invention. Through the movement according to the invention of the pressing means along the top of the stack, a particularly high and uniform adhesive effect for a secure connection of respectively two adjacent layers of the creased sheets and thus for a secure stack formation is achieved. Thus the solution according to the invention leads to a fully automatic, secure and powerful laminating of creased sheets for the purpose of forming a book block with very high quality.

Preferred embodiments and further developments of the invention are given in the dependent claims.

It is therefore preferred that at least one pressing means is embodied as a roller that is rolled on the surface of the top of the stack. In this embodiment accordingly a rubbing roller, a pressure roller or a laminating roller is used as pressing means, which rubs the respectively top creased sheet against or on the previously formed sheet stack and presses it thereto.

In a further preferred embodiment of the invention a plurality of pressing means is provided, of which one pressing means generates pressure on the second outside of a respectively new sheet aligned by the alignment device. Thus with this embodiment for each new sheet a pressing means can be provided, which is assigned to this sheet.

In a further development of this embodiment, the pressing means are moved consecutively through the stack forming area. To this end the pressing means can preferably be supported in a moveable manner along a closed guide path running through the stack forming area. The pressing means thus operate in continuous operation, which is an advantage for a continuous process and in particular for a fully automatic operation.

In particular with a constant work cycle, the pressing means in the previously described further development should be arranged equidistantly from one another along the guide path so that the distance between respectively two adjacent pressing means is essentially constant.

Another preferred embodiment of the invention is characterized in that the abutting means has an abutting plane delimiting the stack forming area and essentially standing vertically upright, against which the stack can be placed, and the alignment device is embodied such that it brings the respective sheet adjacent to the abutting means into a position in which the sheet is aligned at an angle, preferably at an angle of at least 45° and no more than 85° to the horizontal.

Furthermore, the alignment device preferably has a lower stop arranged adjacent to the abutting means, likewise delimiting the stack forming area, and is embodied such that it brings a creased sheet with the crease edge thereof bearing against the lower stop.

The movement sequence according to the two previously given preferred embodiments of the invention is particularly advantageous for an automatic process and a continuous operation. Because the sheets in particular are brought from a horizontal alignment into a position tilted downwards or essentially even vertical, it is possible to support the sheets on the underside thereof and to guide them such that during this the top thereof can be easily firstly provided with adhesive and glued therewith and subsequently can be aligned to the abutting means and thus to the stack already formed there.

In a joint further development to the two previously given preferred embodiments, the pressing means is moved in the upward direction through the stack forming area. The advantage of this further development is in particular that due to the movement of the pressing means along the newly delivered and aligned sheet with simultaneous pressure application in the direction of the stack already previously formed at the abutting means, both already creased layers of this sheet come to rest on the one hand against one another and on the other hand jointly flat against the previously formed stack.

A further preferred embodiment of the invention is characterized in that the pressing device has an additional pressing element that is arranged in an essentially stationary manner adjacent to the abutting means and embodied to generate pressure on the second outside of that creased sheet in an edge section adjacent to the crease edge or adjoining the crease edge in order to press this edge section of the sheet in the direction of the abutting means and thus against the stack. Preferably, the additional pressing element is arranged adjacent to the lower stop. Furthermore, the additional pressing element can be arranged so that it can be brought, preferably pivoted between an operating position in which it generates pressure on the second outside of each creased sheet in an edge section adjacent to the crease edge or adjoining the crease edge and a rest position, and thereby is preferably embodied in a plate-like manner and with its lower section supported in a pivotable manner about an essentially horizontal pivot axis. The additional pressing element provides in an advantageous manner an additional stationary fixing of the respectively newly fed sheet to the stack already previously formed, which has a positive effect on the quality of the stack forming.

Preferably, the abutting means holding the stack can be adjusted by means of an adjustment device such that during the formation of the stack the top thereof remains essentially stationary in essentially the same, preferably approximately vertical plane. With a measure of this type the sequence during the alignment and arrangement of the respectively newly fed sheet on the top of the stack already formed on the abutting means can be simplified, since an essentially stationary and spatially unchanging position is available for the alignment and arrangement of the sheet. This applies in particular when the pressing means is guided along a fixed path or a fixed track through the stack forming area.

A further preferred embodiment with a conveyor device, which is provided for removing a preferably finished stack from the stack forming area, is characterized in that the conveyor device has a gripper arranged adjacent to the abutting means preferably below the abutting means, which is aligned and embodied such that its jaws can be brought into clamping engagement with an edge section of the stack located adjacent to the crease edges of the sheet or adjoining the crease edges of the sheet. Using a gripper, the jaws of which come into engagement with the edge section of the stack adjacent to the crease edges of the sheets, as a conveyor device for removing the stack from the stack forming area has the advantage that the area of the stack forming the subsequent book spine is pressed additionally once again, in order at this point to cause a particularly secure adhesion, and this pressing operation is also used at the same time for removing the stack from the stack forming area.

In a further preferred embodiment an adhesive application station is used in order to apply adhesive to the first outside of the creased sheets, the first outside of the sheets being the top, and a conveyor device is provided, which conveys already folded sheets with their crease edge in front approximately in horizontal alignment essentially one after the other into the adhesive application station. Thus the top of the sheets is glued when they are approximately in horizontal alignment and are thereby guided through the adhesive application station. According to the invention, in this embodiment a transfer device is additionally provided, which connects the adhesive application station to the stack forming station located downstream and has a conveyor means on which the creased sheets provided with adhesive bear with their second outside forming the underside and with their crease edge in front are transported essentially one after the other from the adhesive application station to the stack forming station.

In a further development of the previously mentioned preferred embodiment, the conveyor means is embodied such that it transfers the creased sheets provided with adhesive out of the essentially horizontal alignment in the region of the adhesive application station into the previously mentioned position tilted downwards in the region of the alignment device. To this end it is particularly advantageous to use a conveyor belt endlessly circulating, preferably embodied as a suction belt as a conveyor means, the upper strand of which, which bears the creased sheets provided on their top with adhesive on the underside thereof, has a course curved vertically downwards.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically in side view an arrangement of a conveyor station, an adhesive application station, a transfer station and a stack forming station;

FIG. 2 diagrammatically in side view an enlarged sectional representation of the adhesive application station from the arrangement of FIG. 1;

FIG. 3 diagrammatically in side view an enlarged sectional representation of the stack forming station from the arrangement of FIG. 1; and

FIG. 4 a perspective view of a section of the stack forming station.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The device shown in the figures is used in particular to laminate folded sheets for the purpose of producing a photo book block and is part of an installation for producing such book blocks. To this end a material web unwound from a roll is printed in a printing station, not shown in the figures; alternatively or additionally, however, it is also conceivable that the material web delivered wound up on the roll has already been printed and/or coated and/or exposed. Printed sheets are subsequently separated from the material web by cross-cutting. Alternatively, finished printed and/or coated and/or exposed sheets can also be provided, for example, by means of a sheet feeder. The sheets are folded or creased along a fold line or crease line so that the crease line forms a fold edge or crease edge.

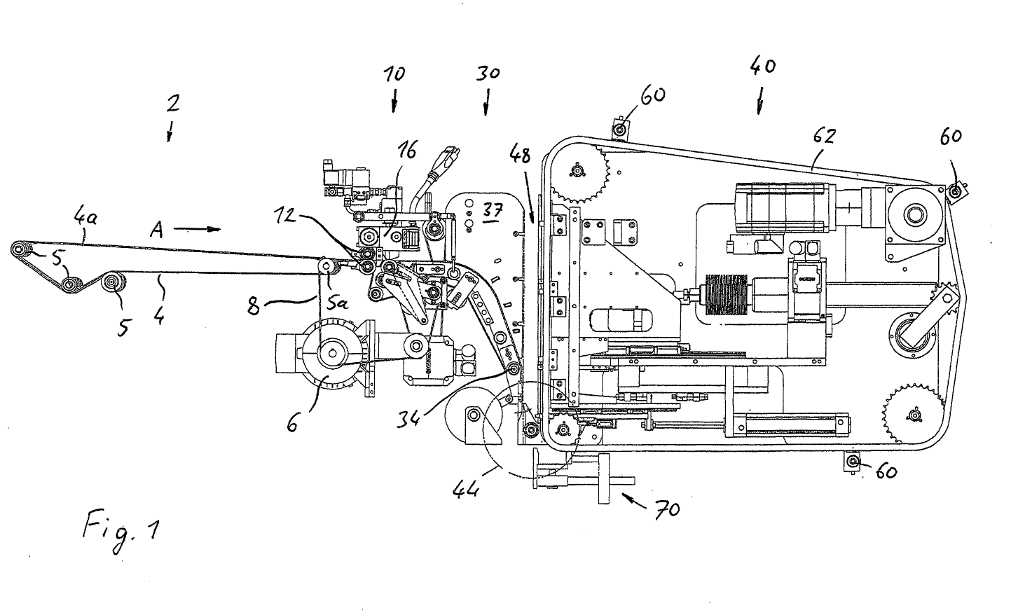

The creased sheets, which are not shown in the figures either, are fed by means of a transport station 2, which is part of the arrangement shown in FIG. 1. The transport station 2 has an endless conveyor belt 4, which is guided around several rollers 5 and 5a. The conveyor belt 4 is driven by a drive motor 6, the output shaft of which in the exemplary embodiment shown is coupled via a drive belt 8 to the roller 5a located downstream, about which the conveyor belt 4 is deflected. Preferably, several of these conveyor belts are provided as individual narrow conveyor belts spaced apart in a parallel manner. Moreover, the conveyor belt 4 can also be embodied as a suction conveyor belt. The creased sheets arrive with their crease edge in front one after the other on the upper strand 4a of the conveyor belt 4. By means of the tilted position of the upper strand 4a of the conveyor belt 4, the sheets can be guided along a lateral web not shown in the figures, which web defines the so-called machine zero edge. In the arrangement shown the transport station 2 serves to transport the sheets, not shown, in the transport direction according to arrow A, which at the same time also indicates the process direction, into a downstream adhesive application station 10, wherein at the same time an alignment of the sheets to the lateral web previously mentioned and thus to the machine zero edge takes place.

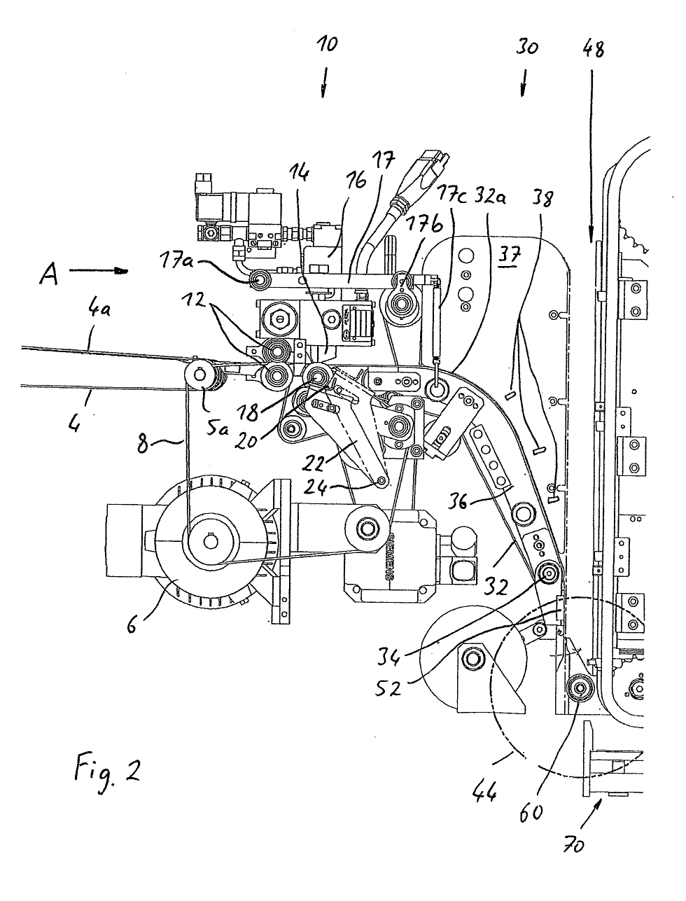

As can be seen in particular from FIG. 2, the adhesive application station 10 has a pair of feed rolls 12, a glue nozzle strip 14, a gluing device 16 connected to the glue nozzle strip 14, a further transport roll 18 and a glue collection strip 20. The conveyor belt 4 of the transport station 2 is aligned with its upper strand 4a such that it transports a sheet up to the feed rolls 12, which draw the sheet into the adhesive application station 10 at the same speed. The feed rolls 12 are likewise driven by the drive motor 6 via the drive belt 8. In the exemplary embodiment shown the further transport roll 18 is arranged downstream, seen in the transport direction according to arrow A, and thereby lies below the glue nozzle strip 14. After the sheet, not shown in the figures, has been drawn between the feed rolls 12 and also has come into engagement with the transport roll 18 located downstream, the sheet is now correspondingly clamped and is carried on its underside by the transport roll 18 in order to be guided past under the glue nozzle strip 14. The top of the sheet is thereby exposed and can therefore be glued unhindered over its entire surface by the glue nozzle strip 14.

The glue nozzle strip 14 or the entire gluing apparatus 16 with the glue nozzle strip 14 can be brought between a rest position and an operating position and, for example, supported in a pivotable manner between an upper rest position and a lower operating position. To this end in the exemplary embodiment shown the gluing device 16 is attached to a frame 17, which is supported in a rotatable manner about a rotation point 17a on a stand, not shown, and is pivoted by an eccentric 17b, which is set in rotational motion by a drive, not shown, is pivoted against the tensile force of a spring 17c between the upper rest position and the lower operating position. The glue nozzle strip 14 is subdivided into segments for a change of format width, which is not shown in the figures either. Likewise, the transport roll 18 can be supported in a pivotable manner below the glue nozzle strip 14 between an operating position, in which it can be brought into engagement for the transport of a sheet with the underside thereof, and a rest position, which is not shown in the figures either.

In the adhesive application station 10 a sensor, not shown in the figures either, is arranged between the pair of feed rolls 12 and the glue nozzle strip 14, which sensor recognizes the arrival and the presence of a sheet. Based on a corresponding signal from a sensor of this type, the gluing device 16 is then correspondingly controlled in order to apply glue from the glue nozzle strip 14 onto the top of the sheet. The glue nozzle strip 14 and the transport roll 18 perform a movement towards one another in order to press the sheet with defined pressure against the glue nozzle strip 14. To this end the glue nozzle strip 14 and the transport roll 18 are supported in a correspondingly moveable manner, which is not shown in the figures either.

After the glue nozzle strip 14 has been placed on the top of the sheet, the glue supply in the gluing device 16 is switched on and the glue from the glue nozzle strip 14 is applied to the top of the sheet. While the sheet, driven by the feed rolls 12 and by the transport roll 18, is glued on its top under the glue nozzle strip 14, the previously mentioned sensor, not shown in the figures, recognizes the trailing edge and thus the end of the sheet and with a defined delay time initiates the interruption of the glue flow and thus the switching off of the gluing device 14. The mentioned defined delay time is thereby measured such that the top of the sheet is fully glued and the dispensing of glue from the glue nozzle strip 14 is switched off shortly before reaching the end of the sheet. In addition to the time control explained above, alternatively or additionally a path control can be provided, which has particular advantages in the case of changing conveyor speeds. When the gluing process is switched off, the glue nozzle strip 14 and the transport roll 18 can be brought or swiveled respectively into their rest position and thereby moved apart from one another.

As FIG. 2 further shows, a glue collection strip 20 is arranged adjacent to the transport roll 18 below the glue nozzle strip 14, which glue collection strip, like the glue nozzle strip 14, extends over the entire width of the transport path. In the exemplary embodiment shown, the glue collection strip 20 is arranged on the upper free end of a lever 22, which can be pivoted about a joint 24 between a rest position and an operating position. In FIGS. 1 and 2 the lever 22 is shown by solid lines in its rest position pivoted downwards and by dashed lines in the operating position pivoted upwards. The glue collection strip 20 can be used to collect excess glue during the gluing operation. However, an essential function of the glue collection strip 20 is to be seen in connection with the rinsing of the glue nozzle strip 14. In the case of a change of format in width, the glue nozzle strip 14 and thus the nozzles located therein are to be rinsed. The rinsing causes a complete filling of the glue nozzle strip 14, which subsequently leads to a uniform application of glue. The quantity of glue that exits from the glue nozzle strip 14 during the rinsing operation can be collected by the glue collection strip 20 and then removed therefrom.

As FIGS. 1 and 2 further show, downstream of the adhesive application station 10 a transfer station 30 is provided, which forms an interface between the adhesive application station 10 and a stack forming station 40, which is explained in greater detail later in the specification. The transfer station 30 has an endless circulating suction belt 32, the upper strand 32a of which forms a continuation of the transport path for the sheets from the adhesive application station 10. In the exemplary embodiment shown, the upper strand 32a of the suction belt 32 has a course curved downwards, namely from an essentially horizontal alignment in its section located upstream in the region of the adhesive application station 10 into an alignment tilted downwards by approx. 70° at its end located downstream adjacent to the stack forming station 40 at a point that is labeled in FIG. 2 by reference number “34” and at which the suction belt 32 is deflected. Preferably, several suction belts of this type can be provided, which are arranged parallel at a distance from one another. Moreover, the suction belt 32 should satisfy high temperature requirements at this point.

The suction belt 32 runs essentially around an Uhle box 36 in which a vacuum is produced by a suction device not shown in the figures. In the top of the Uhle box 36, on which the upper strand 32a of the suction belt 32 bears, suction holes are embodied which are not discernible in the figures, however. In a similar manner the suction belt 32 is also provided with holes, which are not discernible in the figures either. Thus a vacuum is produced on the outer upper side of the upper strand 32a of the suction band 32, whereby the sheet leaving the adhesive application station 10 is fixed with its underside on the top of the upper strand 32a of the suction belt 32. In this manner the sheet now glued on its top is held by its underside on the suction belt 32 and is transported from a horizontal alignment in the region of the adhesive application station 10 in the direction of the point labeled by reference number “34” into the vertical and thereby transferred into an alignment tilted markedly downwards. For a secure guidance, side panels are arranged on both sides of the suction belt 32, of which side panels in FIGS. 1 and 2 only the rear side panel 37 is shown.

Since the sheet is already transported in the creased condition and with its crease edge in front through the adhesive application station 10, only the top of the upper layer is glued and the creased sheet with the underside of the lower layer comes into engagement with the suction belt 32 of the transfer station 30.

Since the transfer station 30 ensures that the creased sheet with its crease edge in front is transported into the vertical and thereby is transferred into an alignment tilted markedly downwards in the region of the point labeled by reference number “34,” there is a danger that the creased sheet now essentially lying upside down will unfold accidently. The unfolding of the sheet is promoted in particular by the fact that the sheet adheres to the suction belt 32 only with the underside of its lower layer, while the upper layer thereof is not fixed in this respect and is even weighted with the glue, wherein an accidental unfolding is even promoted. In order to prevent such an accidental unfolding of the creased sheet during its transport through the transfer station 30, on the inside of the side panels spring plates are arranged at a relatively small distance from the top of the upper strand 32a of the suction belt 32, which serve as abutment or stops and the diagrammatic representation of which is labeled in FIG. 2 by reference number “38.”

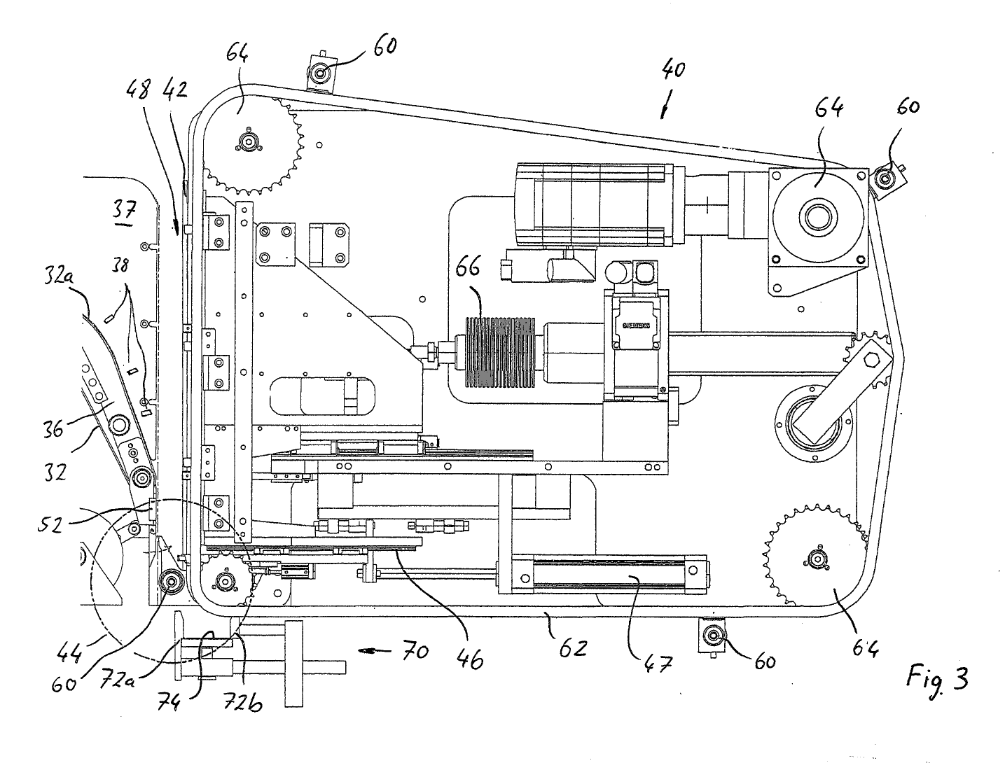

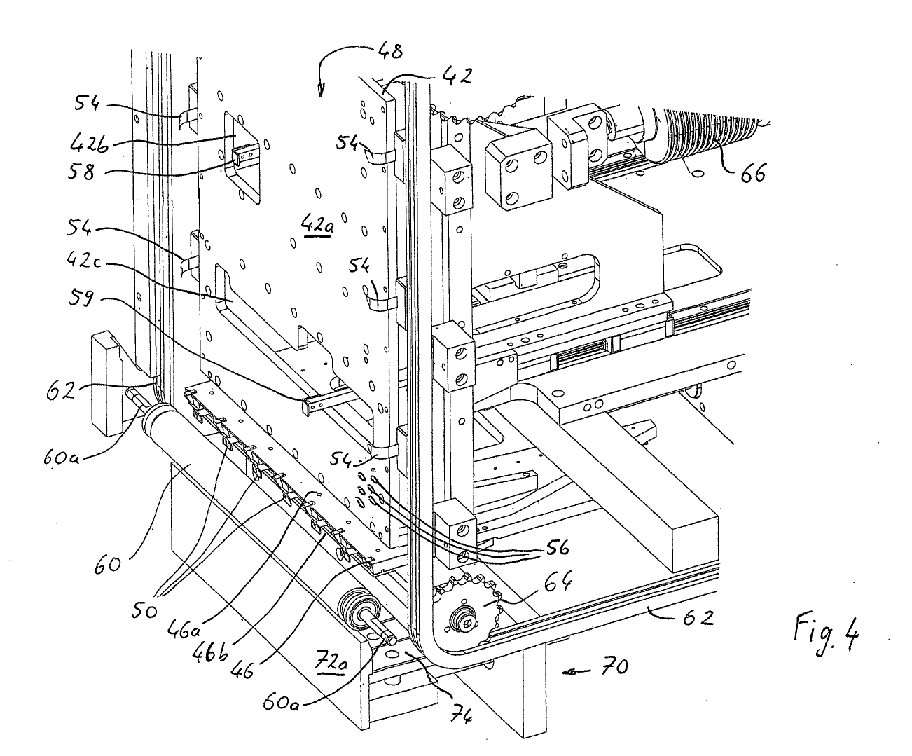

The glued creased sheet is aligned into the above-mentioned tilted position by the transfer station 30 such that the glued top of the upper layer of the creased sheet points towards a lift table or an abutment plate 42. As FIGS. 3 and 4 in particular show, the abutment plate 42 is arranged vertically on the side of the stack forming station 40 lying upstream and adjacent to the transfer station 30, so that the surface 42a of which in the exemplary embodiment shown forms a vertical plane (FIG. 4). By the consecutive feed of creased sheets, in the manner described in further detail below on the surface 42a of the abutment plate 42 a stack, not shown in the figures, is produced. To this end therefore the creased sheets already glued and fed one after the other are placed on the surface 42a of the abutment plate 42. Since the surface 42a of the abutment plate 45 as it were forms the base of the stack, but is aligned vertically in the exemplary embodiment shown, the stack is formed on the surface 42a of the abutment plate 42 in the horizontal direction and therefore does not lie horizontally but stands upright or on edge.

To align the sheets fed consecutively from the transfer station 30, a so-called alignment area is provided, which in FIG. 3 is marked by a dashed circle, which is labeled by reference number “44.” This includes a horizontally arranged, plate-like base slide 46, the surface 46a of which (FIG. 4) in the exemplary embodiment shown forms a horizontal plane. The base slide 46 is supported in a displaceable manner with the aid of an adjustment device 47 between a rest position and an operating position. In the rest position, the base slide 46, which like the adjustment device 47 belongs to the stack forming station 40, is fully inserted into the stack forming station 40; in FIGS. 3 and 4 the base slide 46 is shown in its operating position. While the surface 42a of the abutment plate 42 represents a rear lateral delimitation of a stack forming area 48, the stack forming area 48 is formed at the bottom by the surface 46a of the base slide 46 extended into its operating position according to FIG. 4. As FIG. 4 further shows, along the free edge 46b several clamping fingers 50 are arranged, which in the exemplary embodiment shown can be pivoted about 90° between a rest position and an operating position. In the rest position in which they are shown in FIG. 4, the pivot fingers are aligned in the horizontal direction parallel to the top 46a and the edge 46b of the base slide 46. In order to reach the operating position, the clamping fingers 50 are pivoted upwards by 90° so that they now project upwards beyond the top 46a of the base slide 46, which is not shown in the figures, however.

Furthermore, the alignment area 44 also includes a press plate 52, which is arranged adjacently below the point labeled by reference number “34” and thus the downstream end of the transfer station 30. The press plate 52 is supported so it can be brought, preferably swiveled between an opened position and a closed position. In FIGS. 1 through 3 the press plate 52 is shown in its closed position. In the opened position the distance of the press plate 52 from the abutment plate 42 is larger so that the press plate 52 is to be moved to the left in the representation of FIGS. 1 through 3 in order to bring it into the opened position.

The press plate 52 has the function of bringing the sheet in the direction of the surface 42a of the abutment plate 42 and thus of guiding it into the stack forming station 40. To this end the press plate 52 is first located in its opened position. When a new folded sheet is fed with its crease edge in front by the suction belt 32 to the transfer station 30, the press plate 52 is moved into its closed position and brought to bear against the lower edge section of the sheet adjacent to its crease edge. The sheet with its crease edge thereby comes to bear against the top 46a of the base slide 46 already in its extended operating position, while the clamping fingers 50 are still in their rest position. The sheet is then pressed in the direction of the abutment plate 42 by the press plate 52 and thereby against the stack already formed there. At the same time, the clamping fingers 50 are pivoted into their upright operating position in order to grasp the sheet and to fix it on the base slide 46.

As FIG. 4 further shows, spring plates 54 curved inwards are arranged along the two vertical sides of the surface 42a of the abutment plate 42, which spring plates are used to fix the stack already formed on the abutment plate 42. The surface 42a of the abutment plate 42 is provided with a plurality of holes, which are suction openings that are connected by hoses and/or pipelines (not shown) to a suction device, which is not shown either. Of these suction openings, by way of example a few suction openings are labeled by reference number “56” in FIG. 4. The abutment plate 42 thus acts as a suction plate. As a result of the vacuum formed in this manner on the surface 42a of the abutment plate 42 in particular the first sheet is held on the abutment plate 42, since the first sheet is not glued. In contrast, each further folded sheet due to the glue on its top is adhered to the unglued underside of the respectively uppermost sheet of the stack.

As FIG. 4 further shows, in the exemplary embodiment shown the abutment plate 42 is provided with a first cutout 42b, in which a first retaining finger 58 is located which is supported in a moveable manner by means of an adjustment device, not shown, between a retracted rest position and an extended operating position in the stack forming station 40. Furthermore, in the exemplary embodiment shown, the abutment plate 42 is provided with a further cutout 42c, which extends over almost the entire width of the abutment plate 42 and accommodates a second retaining finger 59, which is adjustable by means of an adjustment device, not shown, not only between a rest position retracted into the stack forming station 40 and an operating position extended therefrom, but also over the entire length of the cutout 42c. These retaining fingers 58, 59 are used as an alternative to the curved spring plates 54 with narrower formats in order to stabilize the stack bearing against the surface 42a of the abutment plate 42.

In order to adhere the glued top of each newly fed creased sheet to the unglued underside of the respectively uppermost sheet of the stack formed up to this time on the abutment plate 42, the newly fed sheet must be pressed over the entire surface against the stack already formed. This occurs in the exemplary embodiment shown with the aid of a laminating roll or pressure roll 60, which moves upwards from the bottom through the stack forming area 48 and rubs the new sheet against the stack in the manner of a rolling pin.

In the exemplary embodiment shown several pressure rolls 60 are moveably supported along a closed guide path running through the stack forming area 48, which guide path is not shown in the figures, and thereby arranged essentially equidistantly from one another. To this end in the exemplary embodiment shown two conveyor chains spaced apart from one another are provided, of which one conveyor chain is arranged on the one side of the stack forming station 40 and the other conveyor chain is arranged on the opposite other side of the stack forming station 40 and is guided over deflection rollers. In FIG. 3 the conveyor chain 62 facing towards the viewer is discernible, which is guided by gear wheels 64 and is deflected thereby, which are supported in a rotatable manner in the stack forming station 40. The arrangement and the course of the two conveyor chains 62 are identical. Between the two conveyor chains 62 the pressure rolls 60 are arranged horizontally, in that they are supported with a journal 60a at their respective end (FIG. 4) in a bearing element, not shown, which is attached to the assigned conveyor chain 62.

So that the conveyor chains 62 can perform a circulating movement, at least one of the rollers 64 is set in rotation by a drive unit, not characterized in further detail. According to the representation of FIGS. 1, 3 and 4, the circulating operation takes place in the clockwise direction. A continuous and fully automatic operation can be realized by the circulating operation, in that a pressure roll 60 is provided for each newly supplied sheet. The distance between two adjacent pressure rolls and the work cycle of the system are to be measured or adjusted depending on one another such that a new pressure roll 60 is provided for each newly supplied sheet.

The same procedure described above applies to each further glued sheet delivered. The clamping fingers 50 (FIG. 4) hold back the already formed and laminated stack and ensure a precise placement of the newly delivered sheet to be laminated. With each laminating operation one of the pressure rolls 60 moves upwards through the stack forming area 48 and rubs the new sheet against the stack on the abutment plate 42.

As FIG. 3 in particular further shows, the stack forming station 40, which can alternatively also be referred to as a laminating station, has an adjustment device 66 in order to adjust the abutment plate 42 in the horizontal direction and thus perpendicular to the vertical surface 42a thereof. The abutment plate 42 is thereby drawn back during the stack formation by the adjustment device 66 in a clocked manner such that the top of the stack remains essentially stationary. Accordingly, the abutment plate 42 is displaced continuously into the stack forming station 40 by the adjustment device 66 depending on the thickness of the stack and depending on the increasing height or thickness of the growing stack, and thus to the right according to the representation of the figures. The distance of the pressure roles 60 guided through the stack forming area 48 thus does not need to be newly adjusted individually depending on the current height or thickness of the stack formed up to that point, instead a constant guidance is sufficient that is consistent for all pressure rolls 60 through the stack forming area 48, which is an advantage structurally.

After completion of the stack with the respectively predetermined number of sheets and the end of the previously described laminating operation, the base slide 46 is retracted by the adjustment device 47 from its operating position shown in FIGS. 3 and 4 in the representation according to FIGS. 3 and 4 to the right into the rest position. The lower stop of the stack forming area 48 thus disappears or the base opens and the stack falls in the direction of its longitudinal extension vertically downwards. However, the stack is caught by a gripper 70 located below, which is discernible in FIGS. 3 and 4. The gripper 70 has two jaws 72a, 72b movable towards one another for opening and closing the gripper 70 as well as a stop 74. After the opening of the base slide 46, the finished stack thus falls with the crease edges, lying one on top of the other, of the sheets subsequently forming the book spine onto this stop 74 with opened jaws 72a, 72b. Subsequently, the jaws 72a, 72b are closed, whereby on the one hand the area of the stack later forming the book spine is correspondingly pressed and shaped and on the other hand the stack is grasped by the gripper 70 and drawn downwards out of the stack forming station 40. Accordingly, the gripper 70 is arranged moveably on a holder, not shown, and is actuated by a drive, not shown either, which preferably operates electropneumatically or electromechanically and preferably can be embodied as a linear drive.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A device for producing a book block, which is composed of layers of sheets connected to one another and creased along a crease line forming a crease edge, with a stack forming station (40), which in a stack forming area (48) assembles creased sheets, provided with glue on their first outside, to form a stack for forming a book block and an abutting means (42) delimiting the stack forming area (48) for holding the stack and a pressing device with at least one pressing means (60), which is embodied to generate pressure on the top of the stack in order to press the stack against the abutting means (42), characterized in that during the generation of pressure on the top of the stack, the pressing means (60) can be moved along the top of the stack through the stack forming area (48) at the same time, and the stack forming station (40) has an alignment device (44), which aligns a creased sheet with its first outside provided with adhesive to the abutting means (42) and thus to a sheet or stack already held on the abutting means (42), wherein the pressing device is furthermore embodied such that the pressing means (60) generates pressure on the second outside of each creased sheet after this sheet has been aligned by the alignment device (44) with its first outside provided with adhesive to the abutting means (42) and thus to the stack held on the abutting means (42), in order to press this sheet against the stack.

2. The device according to claim 1, characterized in that the at least one pressing means (60) is a roller that is rolled on the surface of the top of the stack.

3. The device according to claim 1, characterized in that a plurality of pressing means (60) is provided, of which one pressing means (60) generates pressure on the second outside of a respectively new sheet aligned by the alignment device (44), wherein the pressing means (60) can be moved consecutively through the stack forming area (48).

4. The device according to claim 3, characterized in that pressing means (60) are supported in a moveable manner along a closed guide path (62) running through the stack forming area (48), wherein the pressing means (60) are arranged essentially equidistantly from one another along the guide path (62).

5. The device according to claim 1, characterized in that the abutting means (42) has an abutting plane (42a) delimiting the stack forming area (48) and essentially standing vertically upright, against which the stack can be placed, and the alignment device (44) is embodied such that it brings the respective sheet adjacent to the abutting means (42) into a position in which the sheet is aligned at an angle, preferably at an angle of at least 45° and no more than 85° to the horizontal.

6. The device according to claim 1, characterized in that the alignment device (44) has a lower stop (46) arranged adjacent to the abutting means (42), likewise delimiting the stack forming area (48), and is embodied such that it brings a creased sheet with the crease edge thereof bearing against the lower stop (46).

7. The device according to claim 5, characterized in that the pressing means (60) can be moved in the upward direction through the stack forming area (48).

8. The device according to claim 6, characterized in that the lower stop (46) is arranged in a moveable manner between an operating position, in which it delimits the stack forming area (48) at the bottom, and a rest position, in which it is at a distance from the stack forming area (48).

9. The device according to claim 1, characterized in that the pressing device (44) has an additional pressing element (52) that is arranged adjacent to the abutting means (42) and in an essentially stationary manner to the lower stop (46) and is embodied to generate pressure on the second outside of each creased sheet in an edge section adjacent to the crease edge or adjoining the crease edge in order to press this edge section of the sheet in the direction of the abutting means (42) and thus against the stack.

10. The device according to claim 9, characterized in that the additional pressing element (52) can be brought, preferably pivoted, between an operating position in which it generates pressure on the second outside of each creased sheet in the said edge section and a rest position.

11. The device according to claim 10, characterized in that the additional pressing element (52) is embodied in a plate-like manner and is supported in a pivotable manner about an essentially horizontal pivot axis.

12. The device according to claim 1, characterized by an adjustment device (66) for adjusting the abutment means (42) such that during the formation of the stack the top thereof remains essentially stationary in essentially the same, preferably approximately vertical plane.

13. The device according to claim 1, with a conveyor device, which is embodied for removing a preferably finished stack from the stack forming area (48), characterized in that the conveyor device has a gripper (70) arranged adjacent to the abutting means (42), preferably below the abutting means (42), which gripper is aligned and embodied such that its jaws (72a, 72b) can be brought into clamping engagement with an edge section of the stack located adjacent to the crease edges of the sheets or adjoining the crease edges of the sheets.

14. The device according to claim 1, with an adhesive application station (10) which applies adhesive to the first outside of the creased sheets, the first outside of the sheets being the top, and with a conveyor device (2), which conveys already creased sheets with their crease edge in front approximately in horizontal alignment essentially one after the other into the adhesive application station (10), characterized by a transfer device (30), which connects the adhesive application station (10) to the stack forming station (40) located downstream and has a conveyor means (32) on which the creased sheets provided with adhesive bear with their second outside forming the underside and with their crease edge in front are transported essentially one after the other from the adhesive application station (10) to the stack forming station (40).

15. The device according to claim 14, characterized in that the conveyor means (32) is embodied such that it transfers the creased sheets provided with adhesive out of the essentially horizontal alignment in the region of the adhesive application station (10) into the position tilted downwards in the region (34) of the alignment device (44).

16. The device according to claim 14, characterized in that the conveyor means has a conveyor belt (32) endlessly circulating, preferably embodied as a suction belt, the upper strand (32a) of which, which bears the creased sheets provided with adhesive, has a course curved vertically downwards.
